(19) United States
(12) Patent Application Publication
(10) Pub. No.: US 2002/0188360 A1
(43) Pub. Date: Dec. 12, 2002

(54) Tournament system utilizing a network

(76) Inventors: Masashi Muramori, Kanagawa (JP); Daisaku Ikejiri, Tokyo (JP)

Correspondence Address: KATTEN MUCHIN ZAVIS ROSENMAN, 575 MADISON AVENUE, NEW YORK, NY, 10022-2585, US

(21) Appl. No.: 10/128,994

(22) Filed: Apr. 23, 2002

(30) Foreign Application Priority Data
Jun. 12, 2001 (JP) 2001-176957
Feb. 28, 2002 (JP) 2002-052508

(51) Int. Cl. G06F 155/00

(52) U.S. Cl. 700/91

(57) ABSTRACT

An organizer of a golf tournament held via a server device on a network obtains sponsors in holding the tournament and, in return for the sponsors bearing the burden of labor and costs required for holding the tournament, performs advertising activities for the sponsors. By doing this, it is possible to hold a tournament with a good amount of funding, thereby lessening the burden on the organizer in labor and cost, and enabling the holding of a tournament having a high degree of reality, similar to an actual tournament.

This application is related to Japanese Patent Application No. 2001-176957 filed on Jun. 12, 2001 and No. 2002-52508 filed on Feb. 28, 2002, based on which this application claims priority under the Paris Convention and the contents of which are incorporated herein by reference.

### BACKGROUND OF THE INVENTION

1. Field of the Invention

The present invention relates to a tournament system, a tournament execution method, a server device, a tournament execution program, and a computer readable recording medium into which is stored a tournament program, suitable for use in a golf tournament or car race held via a network.

2. Description of the Related Art

At present, a known network game system exists which enables players to enjoy playing a game in which they make an on-line connection of their client terminal devices to a server device providing a virtual three-dimensional space. In this type of network game system, a video game is played with the various client devices of each player remaining connected to a server device, information such as the scores and times attained by the players being displayed as rankings for each player at the end of the video game.

In a network game system of the past, however, before the video game it was necessary for each player to make various settings to enable the player's client device to be connected to the network. For this reason, persons not accustomed to making the settings necessary to enable connection to the network are faced with an obstacle even before starting to play the video game, making it difficult for them to participate in network games. Stated differently, it can be said that network game systems of the past positioned the entry “bar” at a high point, thereby preventing many people from easily joining these games.

Additionally, because the client terminal device and remains connected to the server device during the time when a player is participating in a network game, there was a need to pay a high communication fee. In the case of real-time competition games and one-on-one competition games, in which the results of the game of the executed network game depend largely upon the skill of the player, it is only possible for skillful game players to truly enjoy the game. From this standpoint, network game system in the past present difficulties in the very entry into the game, making it impossible for many people to easily enjoy such games.

Because the above-noted network game system is completed operated by a network game administrator, the administrator is required to spend a large amount of money and labor in operating the network game system, so that even in the case in which a tournament is held via a network with the goal of achieving an advertising effect, there is the problem that the administrator cannot provided the player with attractive benefits or prized. For this reason, tournaments held via networks are very different from, for example, tournaments held between professional golfers, and lack reality.

### SUMMARY OF THE INVENTION

Accordingly, in consideration of the above-noted problems, it is an object of the present invention to provide a tournament system, a tournament execution method, a server device, a tournament execution program, and a computer readable recording medium into which is stored a tournament program, which enable easy participation by many people, are low in cost and enjoyable, and which reduce the burden in terms of cost and labor placed on the administrator.

In the present invention, by having the organizer of a tournament held via a server device on a network organize the tournament together with a sponsor that has been previously arranged with, there is a division of the labor and cost required to operate the tournament.

By doing this, cooperation from a sponsor enables a tournament to be held via a network, thereby enabling a reduction in the cost and labor required of the organizer.

With cooperation from sponsors, it is possible to hold a tournament with a high level of funding, thereby enabling the provision of high-priced prizes to players, making it possible to run a tournament that has a high level of reality, similar to that of an actual tournament.

Because a game for a tournament is played off-line using a client terminal device, it is possible to participate easily in the game without having to worry about the connection costs, thereby making enjoyable participation in the tournament possible for more persons at a low cost.

### BRIEF DESCRIPTION OF THE DRAWINGS

FIG. 1 is a drawing showing the system configuration golf tournament system according to an embodiment of the present invention;

FIG. 2 is a drawing showing a listing of tournaments planned throughout the year;

FIG. 3 is a drawing showing the flow from the beginning to the point at which results are announced in each tournament;

FIG. 4 is a flowchart illustrating the operating of a web server device when a member is registered;

FIG. 5 is a drawing showing an example of a member registration screen displayed on a player's monitor device at the time of member registration;

FIG. 6 is a flowchart illustrating the operation of the web server device at the time of entry password acquisition;

FIG. 7 is a drawing showing an example of an entry password display screen;

FIG. 8 is a flowchart illustrating the flow of play in a golf game played off-line by a client terminal device of a player;

FIG. 9 is a drawing showing a score application password display screen displayed at the end of a golf game;

FIG. 10 is a flowchart illustrating the operation of the web server device at the time of score application; and

FIG. 11 is a drawing showing an example of a results announcement screen publicized on a web server device at the end of each tournament.

### DETAILED DESCRIPTION OF THE PREFERRED EMBODIMENTS

The present invention can be applied to a golf tournament system in which a golf tournament in which players compete based on the results of a golf game is held via network.

Configuration of the Golf Tournament System

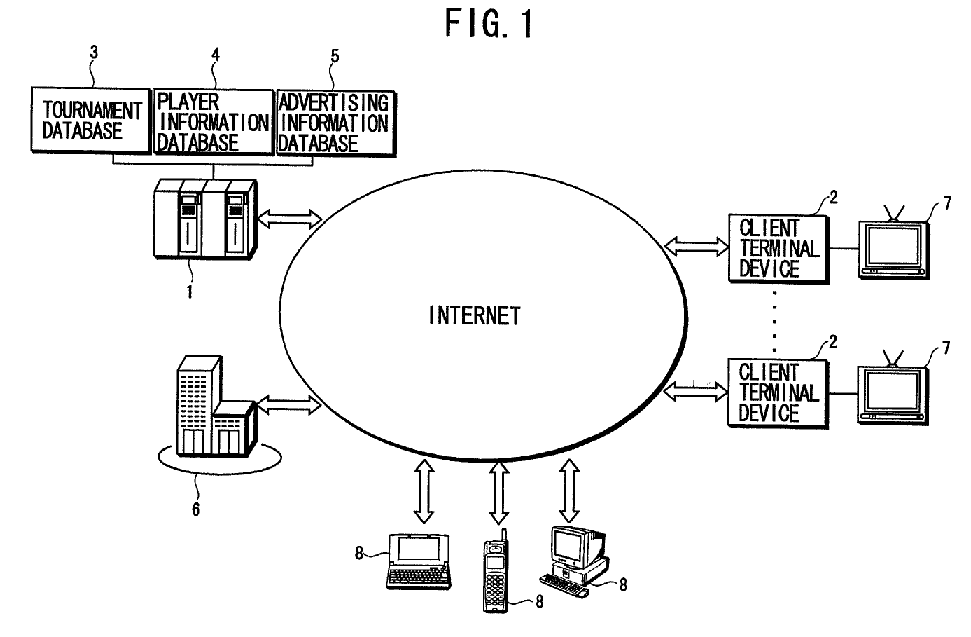

The overall configuration of a golf tournament system according to an embodiment of the present invention is described below, with reference to FIG. 1.

The golf tournament system according to this embodiment, as shown in FIG. 1, has a web server device 1 at the organizer of the golf tournament, and client terminal device 2 of each player playing the golf game for the golf tournament, the web server device 1 and the client terminal devices 2 being connected via a predetermined network such as the Internet.

The web server device 1 has a tournament database 3 for the purpose of storing in HTML (HyperText Markup Language) format various data that is publicized to players via the Internet, including website data, player golf game results, and golf tournament information and the like, and a player information database 4 for the purpose of storing information regarding players participating in a golf tournament.

The web server device 1 has an advertising information database 5 for storing advertising information provided from the server device 6 of a company that is sponsoring a golf tournament, and is configured so as to operate a golf tournament based on the results of a golf game executed on the client terminal device 2, with the support of the sponsoring companies and the like.

The client terminal device 2 is, for example, a video game machine, or a personal computer or the like. In the case in which the client terminal device 2 is a video game machine, operational control of objects in the golf game being executed and instructions related to various processing related to the golf game, such as input of various information are performed using a controller.

In the case in which the client terminal device 2 is a personal computer, instructions related to the golf game are given via a keyboard or mouse, or other such input device.

A monitor device 7 is connected to the client terminal device 2, and game images in accordance with instructions from the client terminal device 2 and game sounds are acoustically output via this monitor device 7.

A golf tournament held using the above-noted type of golf tournament system is held with the support of companies and the like, in which players play a golf game off-line using a client terminal device 2, application for the score resulting from playing this golf game being made to the web server device 1 via a predetermined network such as the Internet.

Overview of a Golf Tournament

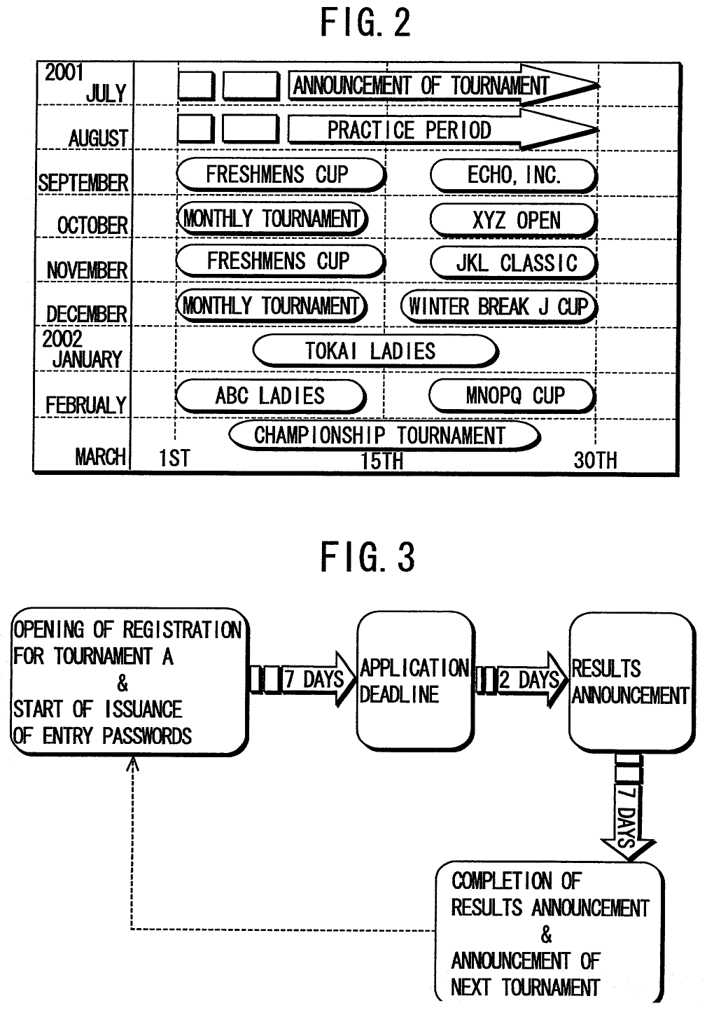

Specifically, golf tournaments held by a golf tournament system according to this embodiment, as shown in FIG. 2, are held over the 7-month period from September of one year through March of the following year. Of these tournaments the ones held from September of one year through February of the following year are preliminary tournaments, in which players attaining good scores are able to go on to play in the championship tournament held in March, the best player of the year being determined by the championship tournament.

These various tournaments are held after each acquires sponsoring companies, and in the case in which a tournament is sponsored by a company call Echo, Inc., for example, the tournament could be held as the Echo Memorial, or if the sponsor is the company ABC, Inc., it could be held as the ABC Classic, so that the name of the sponsor or the name of a product or service provided by the sponsor is reflected in the name of the tournament, just as in the case of tournaments held for professional golfers.

During August, one month before the start of the first preliminary tournament in September, the players each go through a practice period of playing the golf game, and in July, one month before the practice period in August, the organizer of the golf tournament announces the golf tournaments to the players.

For this reason, the organizer notifies players of the tournaments via media such as magazines, advertisements, and the World Wide Web and the like, the players receiving these notices, entering into golf game practice in August, and participating in the Freshmen's Cup, which is the first tournament, held in September.

The flow from the start of each tournament up until the results are announced is as shown by example in FIG. 3, wherein applications for registering of scores are closed 7 days after the issuance of an entry password, the results of the tournament being announced 2 days after this deadline on the web server device 1. The announcement of the tournament results is ended in 7 days, at which point the organizer notifies each of the players of the holding of the next tournament.

The players participate in all the preliminary tournaments up until the championship tournament, in accordance with this flow, or participate in selected preliminary tournaments and compete for the right to go on to the championship tournament.

Operation of the Golf Tournament

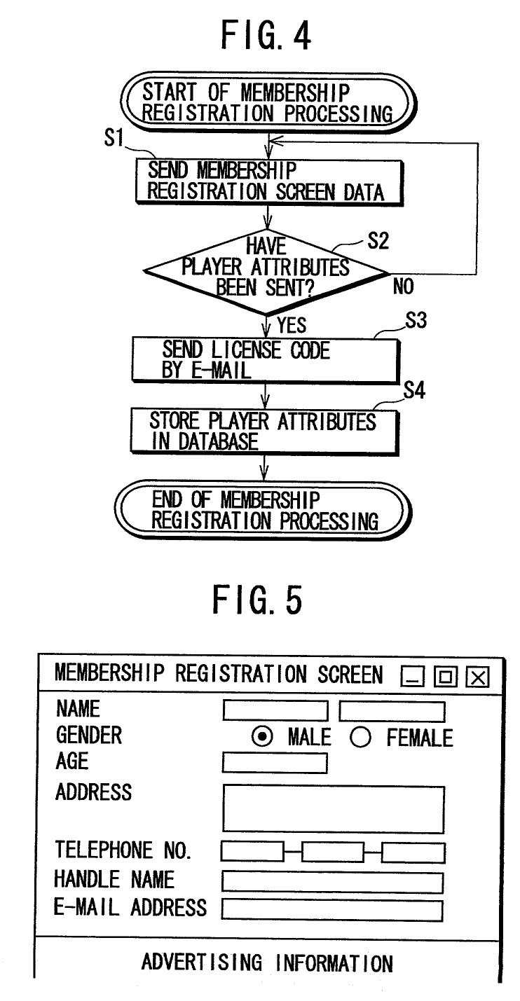

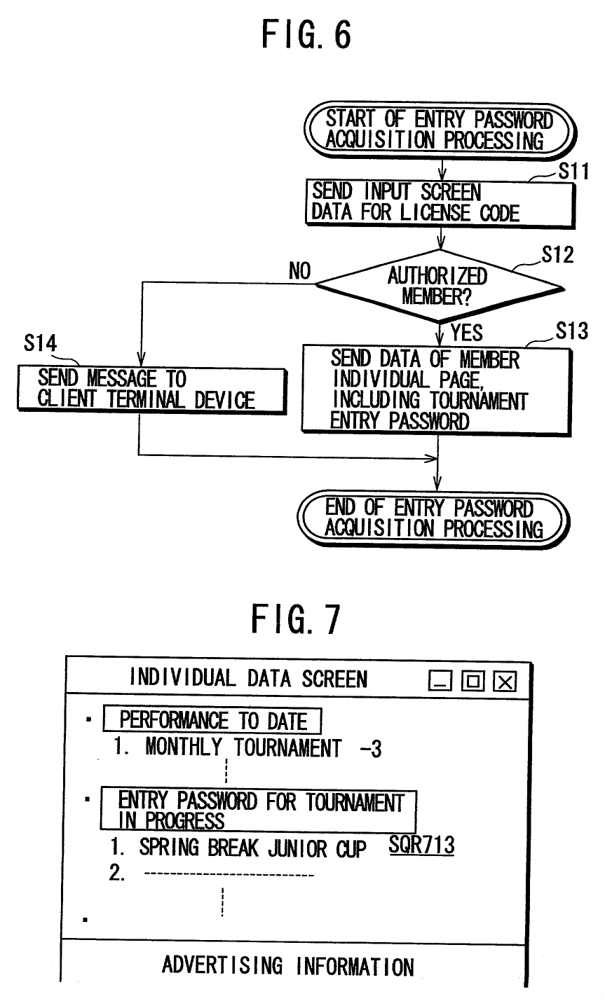

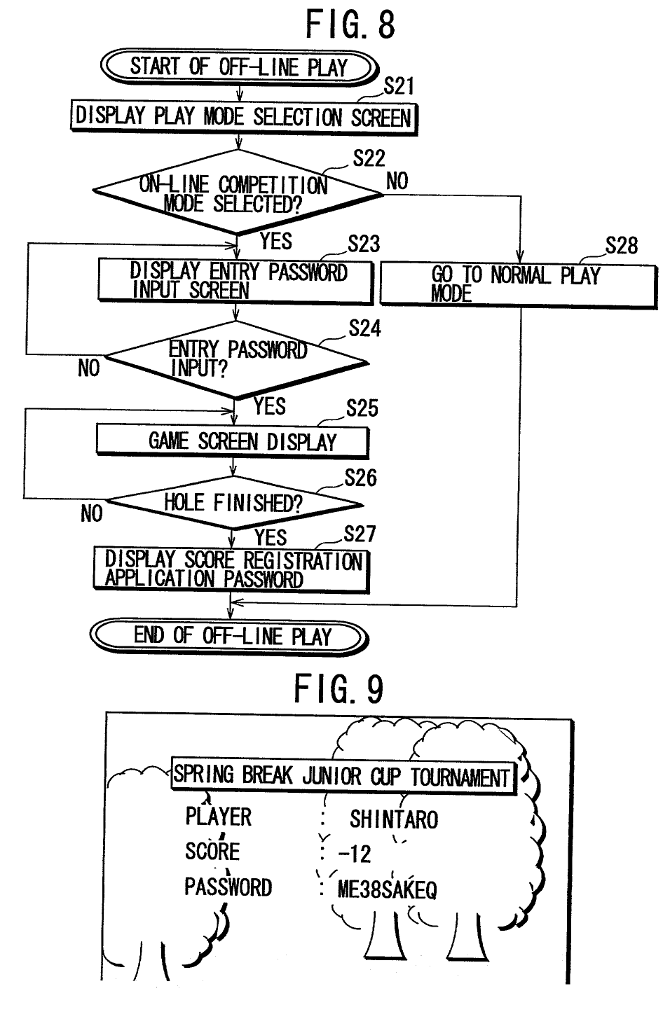

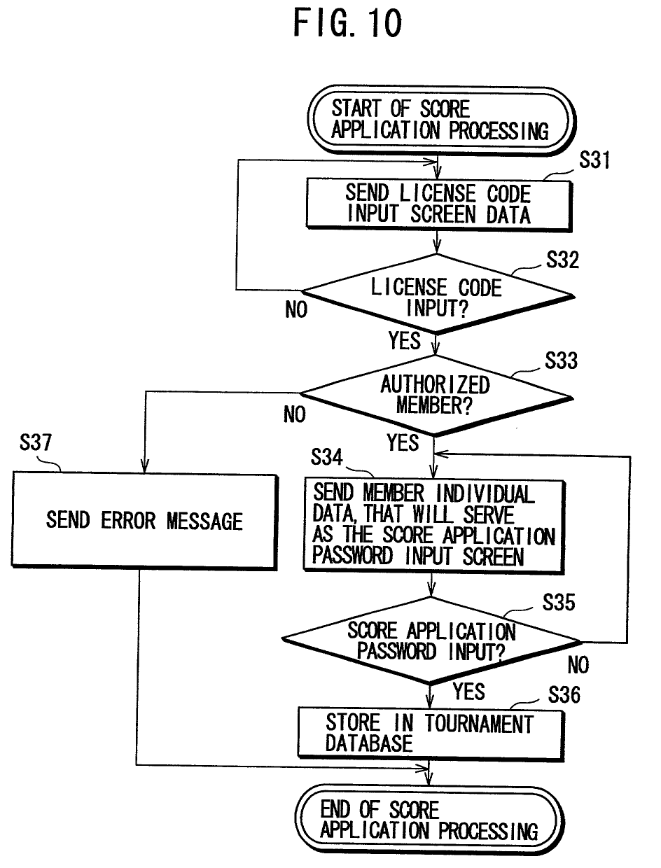

In the above-noted golf tournament system, a player wishing to participate in a tournament performs a membership registration (FIG. 4) with respect to the web server device 1 of the organizer, thereby obtaining a “license code,” and uses this license code to log onto the web server device 1 so as to obtain an “entry password,” which is required to play the golf game for the tournament (FIG. 6). Using this entry password, the player plays the golf game off-line (FIG. 8), and then uses the license code to log onto the web server device 1 and apply for registration of the score that the player has obtained (FIG. 10).

The operation of the web server device 1 in the above-noted member registration, entry password acquisition, and score registration, and the operation of the client terminal device 2 in the above-noted off-line play are each described below.

The client terminal device 2 referred to the following description has a unique client ID for each client terminal device stored in a memory such as a MASK-ROM or the like, this client ID being invisible to the player.

Member Registration

When access by a player occurs via the client terminal device 2, the web server device 1 of the organizer sends to the client terminal device 2 of that player data for an initial screen for causing selection of one of the operations of membership registration, tournament entry password acquisition, entry to a tournament, and score registration application. By doing this, the above-noted selection screen is displayed on the monitor device 7 connected to the client terminal device 2 of the player.

FIG. 4 is a flowchart showing the flow when the web server device 1 of the organizer of a tournament performs registration of the membership of a player desiring to participate in a golf tournament (membership registration process). This flowchart starts with the player selecting “Member Registration” from the above-noted initial screen, the member registration process starting at step S1.

At step S1, the web server device 1 sends data for the member registration screen to the client terminal device 2, thereby causing a display of the member registration screen on the monitor device 7 of the player, at which point the processing flow proceeds to step S2.

The member registration screen is as shown in the example in FIG. 5, in which the screen is provided with input fields for such items as the player's name, gender, age, address, telephone number, “handle name,” and e-mail address.

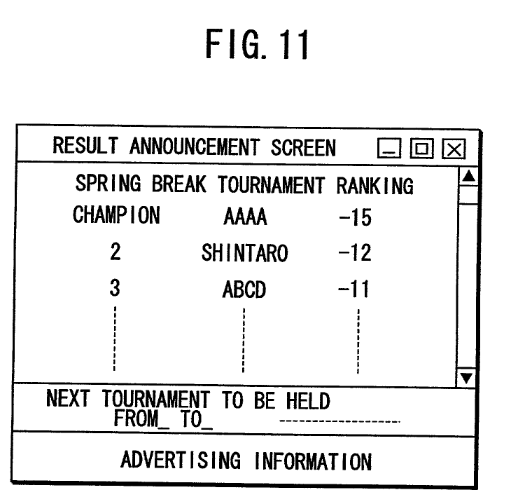

The handle name need only be input if the player wishes to input the handle name, in which case the web server device 1 uses this handle name in such cases as announcing results of a tournament (FIG. 11), to be described further below.

A player makes the respective inputs to these input fields of the member registration screen, the results of these inputs being sent to the web server device 1 as player attribute information. When doing this, the client terminal device 2 sends both the player attribute information input by the player and the client ID, which is an identification number assigned individually to each client terminal device 2, to the web server device 1.

Next, at step S2 the web server device 1 determines whether player attribute information has been sent from the player and, in the case in which player attribute information has not been sent or the case in which player attribute information has not been input by the player, this step S2 is repeatedly executed so as to wait for transmission of the player attribute information. Then, at the time that player attribute information is sent from the player to the web server device 1, processing in the member registration proceeds to step S3.

At step S3, the web server device 1 generates e-mail containing as a license code a player ID and an ID password used when the player logs in to the web server device 1, and sends this e-mail to the e-mail address sent from the player as one of the player attributes. By doing this, the player acquires a license code via an e-mail message sent to the player. This license code is used when the player logs in to the web server device 1.

Next, at step S4 the web server device 1 stores into the player information database 4 shown in FIG. 1, the client ID and associated player attribute information sent from the client terminal device 2 associated with the license code issued to the player, thereby completing the processing for member registration.

As described above, by storing the player attribute information and license code along with the client ID, it is possible to perform registration using not only the player attributes, but also the member registration identifying the client terminal device 2 being used by the player, thereby enabling prevention of improper applications when applying for score registration, the processing for which is described below with reference to FIG. 10.

Entry Password Acquisition

The player next uses the license code acquired as noted above to log in to the web server device 1, and acquire an entry password that is required for participate in a desired tournament.

The flowchart of FIG. 6 show the process of distributing entry passwords performed in the web server device 1. The processing shown in this flowchart starts at step S11 when a player connects his or her client terminal device 2 to the web server device 1 so as to display the initial screen on the monitor device 7, and then selects the “Tournament Entry Password Acquisition” item from this initial screen.

At step S11, the web server device 1 sends “license code (player ID and ID password)” input screen data, appended at the time of the member registration described above, to the client terminal device 2.

At this license code input screen, the player inputs his or her own license code, given at the time of member registration, this being sent to the web server device 1. When the license code is returned from the player, the web server device 1, at step S12, compares the license code returned from the player with the license code stored in the player information database 4 shown in FIG. 1, and determines whether the player currently accessing is an authorized member. If this comparison indicates that the player is not an authorized member, at step S14 a message such as “Register as a member and acquire a license code” to prompt registration, or an error message is sent to the client terminal device 2, at which point the entry password acquisition processing is ended.

If the determination is made, however, that the player is an authorized member, the web server device 1 allows the log-in of that player and, at step S13, performs a search of tournaments in which that player can participate, based on the player attributes of that player stored in the player information database 4.

That is, in the case of this golf tournament system, tournaments are provided in which there is restricted participation, for example tournaments for primary school pupils only, tournaments for women only, and tournaments for participation by people in only a specific region. For this reason, the web server device 1, based on player attributes such as address, gender, and age, which are stored in the player information database 4 at the time of member registration, searches for tournaments in which a specific player can participate, and sends a display screen including the names and the entry passwords for tournaments found from this search to the client terminal device 2. By doing this, the entry passwords for tournaments in which a player can participate are displayed on the monitor device 7 of that player, at which point the process of distributing entry passwords shown in the flowchart of FIG. 6 is ended. The web server device 1 stores the sent entry passwords into the player information database 4 individual for each player.

FIG. 7 shows an example of a display screen for the above-described entry password. In the case of a golf tournament system according to this embodiment, the distribution of entry passwords is performed on a dedicated player screen (individual page). FIG. 7 shows that, of the tournaments currently being organized, the player can participate in the “Spring Break Junior Cup” tournament, and that the entry password required to participate in this tournament is “SQR713.”

Even if a given player accesses a plurality of times with respect to one and the same tournament, different entry passwords are issued at each individual access. For this reason, during the holding of a tournament a player can obtain a plurality of entry passwords, can use these entry password to play the golf game off-line a number of times, and can apply for registration of each of the scores attained in the off-line games. It is also possible before completion of the score registration application processing to be described below to distribute the same entry password and to distribute different entry passwords after completion of the score registration application.

As described above, because the entry password display screen is made up as a dedicated display page for a particular player, in the case in which a tournament in which that player has participated is already finished, it is possible to display the results obtained by that player in that tournament along with the entry password. FIG. 7 indicates that results (until the present) for the player in the “Monthly Tournament” are 3 under par.

Off-Line Play

Next, upon acquisition of an entry password, the player enters the entry password acquired into his or her client terminal device 2 and plays the golf game for the tournament off-line.

The flowchart of FIG. 8 shows the flow of the operation of the client terminal device 2 during off-line play. The processing of this flowchart begins when a recording medium such as a CD-ROM, a DVD-ROM, or a semiconductor memory card is inserted into the client terminal device 2, at which point the client terminal device 2 executes steps starting with step S21, based on the game program.

In this example, although the description is for the case in which the program for the golf tournament system is reproduced and executed from a recording medium such as a CD-ROM or DVD-ROM, it is alternatively possible to download the game program for the golf tournament system to the client terminal device 2, for example from the web server device 1, and to execute the program at the client terminal device 2.

First, at step S21 the client terminal device 2 displays a play mode selection screen on the monitor device 7 for the purpose of having the player select a play mode, and prompts the player to select one of the play modes.

That is, in this golf tournament system three play modes are provided, these being the single play mode, in which the golf game is played without considering participation in a tournament, a practice mode, in which practice is done at a selected hole, and a network competition mode, in which play is done on a course intended for a tournament, after which application is made to register the attained score for competition between players via the network.

The player selects a desired play mode from the above-noted play modes, and at step S22 the client terminal device 2 determines whether or not the player has selected the network (on-line) competition mode from the above-noted play modes. In the case in which the player selects the network competition mode, the processing proceeds to step S23, but if the single play mode or practice mode has been selected, the processing proceeds to step S28, at which point transition is made to one of the play modes selected by the player, this ending the processing of the flowchart of FIG. 8.

At step S23, the client terminal device 2 displays an Entry Password input screen on the monitor device 7.

As described below, in this golf tournament system the score resulting from a game is encrypted using the entry password input by the player, and used to form a score registration application password. For this reason, the client terminal device 2 waits for input of the entry password at step S24, and processing proceeds to step S25 at the point at which the entry password is input.

At step S25, because the player has input the entry password, the client terminal device 2 displays a game screen of the golf game for the tournament. By doing this, the player plays a golf game from hole 1 to hole 18, as in an actual game of golf.

At step S26, the client terminal device 2 determines whether the player has played from hole 1 to hole 18 for the tournament (i.e., whether the player has holed out at hole 18), and waits for the completion of the game before processing is allowed to proceed to step S27.

At step S27, the client terminal device 2 encrypts the score attained by the player upon completing play of the course, using the entry password that was input by the player at the start of the golf game for the tournament, thereby forming a score registration application password, this being displayed on the monitor device 7, at which point the processing for off-line play shown in the flowchart of FIG. 8 is ended.

FIG. 9 shows an example of the score registration application password display screen. This drawing shows that a player with the handle name “SHINTARO” finished the Spring Break Junior Cup Tournament with a score of 12 under par (−12) and has acquired the score registration application password of ME38SAKEQ. As can be seen from FIG. 9, the player's name, the finishing score, and the score registration application password are displayed as a score registration application password screen.

In the case of this golf tournament system, because the score is encrypted using the entry password input by the player as described above, so as to form a score registration application password, if a different entry password was input before the start of the game, the score registration application password will also be accordingly different.

By encrypting the score based on the entry password in this manner, so as to form a score registration application password, one entry password enables only one application for score registration. In the case of this golf tournament system, however, it is possible during the holding of a tournament for one and the same player to acquire a plurality of entry passwords, thereby enabling a plurality of applications for score registration using the plurality of entry passwords.

If the web server device 1 invalidates an entry password used subsequently for encryption of a score registration application as described below, it is only possible for a player to apply for score registration one time with one entry password. As noted above, however, because one and the same player can acquire a plurality of entry passwords, it is possible for a single player to make a plurality of applications for score registration as described below.

Score Registration Application

Next, if a player is satisfied with his or her score resulting from off-line playing of the game, the player applies to the web server device 1 for registration of the score. The flowchart of FIG. 10 shows the flow of score registration application processing in the web server device 1 in response to an application from a player for registration of a score.

The processing shown in the flowchart of FIG. 10 starts when the player connects his or her client terminal device 2 to the web server device 1 of the organizer and selects “Score Registration” from the above-noted initial screen displayed on the monitor device 7, with processing starting from step S31 in this flowchart.

At step S31, the web server device 1 determines whether the currently accessing player is authorized to log in, and sends the above-noted license code input screen data to the client terminal device 2.

By doing this, the license code input screen is displayed on the monitor device 7 connected to the player's client terminal device 2. The player inputs the license code, which is the player ID and the ID password given at the time of member registration, following the input form of the input screen, and sends these to the web server device 1.

When the license code input data is sent at step S31, at step S32 the web server device 1 goes into the condition of waiting for license code response from the player, and processing proceeds to step S33 when the license code is returned from the player.

At step S33, the web server device 1 compares the license code returned from the player with the license code stored in the player information database 4 shown in FIG. 1, and determines whether the currently accessing player is properly registered. If the results of this check indicate that the player is not an authorized member, message such as “Register as a member and acquire a license code” is displayed to prompt registration or an error message is sent to the client terminal device 2, at which point the processing for the score registration application is ended.

In the case in which the player's client terminal device 2 sends a license code to the web server device 1, the client ID is read out from the above-noted MASK-ROM, and both this client ID and the license code are sent. The web server device 1 compares the client ID sent from the player with the client ID of the player stored in the player information database 4 and, if the two coincide, determines that the player is a registered member.

If the result of the above-noted comparison indicates that the player is a properly registered member, the web server device 1 allows the log-in of the player, and at step S34 sends the score registration application password input screen data to the client terminal device 2.

By doing this, the Score Registration Password input screen is displayed on the monitor device 7 connected to the client terminal device 2. The player, in accordance with the input form on this input screen, inputs the score registration application password (ME38SAKEQ shown in FIG. 9) displayed at the completion of off-line play and this is sent to the web server device 1.

When the score registration application password input screen data is sent at the above-noted step S34, at step S35 the web server device 1 waits for return of the score registration application password from the player and processing proceeds to step S36 at the point at which the score registration application password is returned from the player.

At step S36, the web server device 1 decrypts the score registration application password returned from the player using the license code for that player. When this is done, in the case in which a common key is used for the encryption processing of scores in the golf tournament system the web server device 1 decrypts the score registration application password using as a decryption key the player entry password stored in the player information database 4. In the case in which a pubic encryption key is used in the score encryption processing, the web server device 1 decrypts the score registration application password using as a decryption key a secret key generated with respect to the entry password, which is the public key. After that is done, the web server device 1 stores the decrypted score in the tournament database 3 shown in FIG. 1 as the player's score in the tournament. This completes the processing for score registration application shown in the flowchart of FIG. 10.

In the case of holding a golf tournament or the like via a network, although there is the problem of falsification of scores which are the subject of application for registration, in this golf tournament system a score registration application password is formed by encrypting a score using an entry password acquired only by a player who is a properly registered member, the score registration application being made with this password, making it possible to provide secure protection against improprieties such as falsification of scores.

Because client IDs, which are characteristic identification information given to the client terminal devices 2 used by each player are stored in the web server device 1 beforehand, a score is accepted for registration only after comparing with a client ID sent from the client terminal device 2 of a player when the player applies for registration of a score, so that it is possible to accept a score only after identifying a player and the associated client terminal device 2 used by that player, making it possible to provide further prevention of improprieties in score registration application.

With respect to a player who makes an application for registration of a score soon after the start of a tournament, it is possible to grant points to the player in the same manner as is done, for example, in on-line shopping and the like. By doing this, it is possible to encourage players to actively play, and to encourage playing by even players who are not so good at games. It is therefore possible to increase the number of players participating in a tournament, therefore increasing the activity of the tournament being held.

It is also possible to store in the player information database 4 the number of times players have applied for registration of scores, and to grant benefits to players such as the above-noted points with respect to the number of score registration applications. In this case as well, because it is possible to urge players to actively participate in a tournament, it is possible to increase the number of tournament players, and increase the excitement of the tournament being held.

Announcement of Results

As described with reference to FIG. 3, when the period for application of score registration (that is, the period of holding the tournament) has elapsed, the organizer of the tournament closes off applications for score registration, and announces the results of the tournament via the web server device 1.

Specifically, by the players applying for registration of their respective scores, score data for each of the players is accumulated in the tournament database 3 shown in FIG. 1. Thus, after the deadline for applications for score registration, the web server device 1 performs ranking of the players, based on the scores stored in the tournament database 3, and places the ranked results on a webpage of a website of this system.

FIG. 11 shows an example of the tournament results announcement screen, from which it can be seen that in the players AAAA, SHINTARO, and ABCD in the winning, 2^{nd} place, and 3^{rd} positions) attained scores of −15, −12, −11, and so on in the Spring Break Junior Cup tournament, this screen also including an announcement of the next tournament to be held. The players can check their own ranking and level from this type of tournament results announcement screen.

Although in the results announcement screen noted above there is an announcement of the next tournament, it is alternatively possible, for example, for the web server device 1 to generate electronic mail that includes the dates and so on of the next tournament and to distribute this mail to the e-mail addresses stored in the player information database 4. By doing this, it is possible to give notice of the next tournament to be held to players, including players who did not participate in the recently ended tournament.

Sponsor Tie-Up

Next, when one tournament ends a prize such as a predetermined product is awarded to high ranking players. In the case of this golf tournament system, the tournament is held with a tie-up to a sponsor, wherein the organizer of the system has the sponsoring company bear a part of the cost of operating the system and purchasing the product to award to high-ranking players, in return for which advertising is done of the company's products or services.

That is, the organizer of the golf tournament system generates, for example, banner ads or streaming (moving picture) ads for the sponsoring company and stores these into an advertising information database 5 shown in FIG. 1 beforehand, or the sponsoring company makes up its own advertising information, this advertising information being stored in the advertising information database 5 via a web server 6 of the company. The web server device 1 then distributes advertising information stored in the advertising information database 5 when communication is done with the client terminal devices 2 of each of the players.

More specifically, FIG. 5 shows the display screen at the time of member registration and, as shown in FIG. 5, the web server device 1 displays an advertisement for a sponsoring company, which has been stored in the advertising information database 5, in the remaining space at the time of membership registration.

In the same manner, FIG. 7 shows the display screen for the entry password and as shown in FIG. 7 the web server device 1 displays an advertisement for a sponsoring company, which has been stored in the advertising information database 5, in the remaining space on the display.

Additionally, FIG. 11 is a results display screen for the tournament and, as shown in FIG. 11, the web server device 1 displays an advertisement for a sponsoring company, which has been stored in the advertising information database 5, in the remaining space on the display.

By doing this type of advertising, in return for the sponsoring company's bearing part of the cost of operating the system and purchasing products for high-ranking players, it is possible to advertise products and services of the sponsoring company to the players.

Although in the case in which advertising information is stored in a recording medium such as a CD-ROM or DVD-ROM that is played back at the client terminal device 2, it is not possible change or correct the advertising contents afterwards, because this golf tournament system enables each of the sponsoring companies to store its advertising information in the advertising information database 5 on the network, by changing the advertising information in the advertising information database 5 it is possible for each of the sponsoring companies to freely change or correct its advertising. In the case in which the an overwritable recording medium is used in the client terminal device 2, it is possible to display an advertisement by writing the advertisement into the recording medium and then reading the advertisement in the recording medium during off-line play.

It is further possible, either instead of or in conjunction with advertising information, to insert link information to a website of a sponsoring company within the displayed screen. By doing this, it is possible to enable direct access to the website of a sponsoring company in order to request further information, thereby making possible a further improved advertising effect. It is also possible to distribute entry passwords by sending them to players by e-mail, including an advertisement for a sponsoring company as well as a link to the website of the sponsoring company within the e-mail.

It is further possible to conduct a prior survey of the likes of players, to store the results of this survey into the player information database 4, and to refer to the results of the survey in order to distribute advertising to players which is matched to their likings when distributing the advertising as noted above. By doing this, it is possible to perform advertising that matches the likings of each player, thereby achieving highly effective advertising.

As is clear from the foregoing description, in a tournament system according to this embodiment, the administrator of the web server device 1, who is the organizer of the tournament, holds a golf tournament by joint sponsorship with companies and the like. For this reason, it is possible to split the costs of holding the tournament and of operating this system with the sponsors, thereby enabling a reduction in the financial burden on the organizer.

Because the golf tournament is held with the cooperation of companies and the like, it is possible to hold a tournament with full backing for operating costs. For this reason, the organizer of the tournament can hold a tournament with a high degree of reality, offering attractive prizes, services, and other benefits to players of the golf game, similar to the case of an actual tournament participated in by professional golfers. In return for the bearing costs, for example the cost of holding the tournament, sponsoring companies are able to advertise their products or services and the like to players, thereby enabling them to increase their sales or enhance their image through this advertising.

In a tournament system according to this embodiment, it is possible to make the connection to the web server device 1 via the network for only a very limited amount of time for acquisition of an entry password and application to register a score or the like, with the golf game for the tournament being played off-line using the client terminal device 2 of each of the players, thereby enabling playing of the game without having the players be concerned about connection charges to the network. It is possible to save a game or load a game during play, without being concerned about the condition of a connection to the network, thereby enabling interruption and restarting of play in the golf game at any time. It is therefore possible to enable a diverse range of players, ranging from beginners to advanced players to enjoy playing the golf game at a low cost. Because there is no need for the web server device 1 itself to execute the golf game, it is possible to greatly reduce the burden on the web server device 1.

Because the player enjoys participating in a tournament by playing a golf game, the player will play the golf game for a long period of time, thereby making it possible to achieve golf game software that has a long life.

Although in the foregoing embodiment a player uses a client terminal device 2 to establish a connection to the web server device 1, it is alternatively possible, instead of the client terminal device 2, to establish a connection with the web server device 1 using a communication terminal device 8 that is capable of communication connection to the web server device 1, such as a cellular phone, a PDA (personal digital assistant), or a personal computer, such as shown in FIG. 1.

In the case in which strict identification of users is not required, it is possible to perform authentication using a player ID and an ID password only, without using a client ID. Even in this case, however, because the score is encrypted by using the entry password, it is possible to prevent tampering with the score information.

Additionally, although the foregoing embodiment was described for the case in which prizes are awarded to high ranking players, it will be understood that it is alternatively possible to award points usable in on-line shopping, for example, 10,000 points for the champion, 5000 points for the runner-up, and 2000 points to the third-placed player.

Although in the description of the above-noted embodiment the present invention is applied to a golf tournament system, it will be understood that the present invention can also be applied to car races in which riders compete for times, and also in a variety of other tournaments using on-line games.

The operation of the above-noted server device 1 can be programmed and stored in a computer-readable recording medium, in which case when the tournament is to be executed the recording medium is read into a computer system and the program is stored into the memory area of the computer system and executed by the processor of the computer so as to implement the above-described tournament system. The term recording medium as used herein encompasses computer-readable storage media, into which a program can be stored, such as a semiconductor memory, a magnetic disk, an optical disk, and a magneto-optical disk or the like.

Finally, it should be noted that the foregoing embodiment is merely an exemplary form of the present invention, to which the present invention is not restricted, and that the present invention can take other various forms, within the scope of the technical concept thereof, but different from the foregoing described embodiments.

What is claimed is:

1. A tournament system comprising:
a client terminal device, which executes, in an off-line condition, a predetermined game according to operation by a player;
a communication means for performing on-line application for game results of the game executed by the client terminal device; and
a server device, which holds a tournament with the support of a sponsor, in which each player competes for position based on the game results applied for on-line via the communication means.

2. The tournament system according to claim 1, wherein the server device further comprises an advertising information database, into which is stored advertising information of the sponsor, and sends to the communication means of each player participating in the tournament advertising information stored in the advertising information database.

3. The tournament system according to claim 1, wherein the server device issues an entry password for participating in the tournament to each player individually via a predetermined network,
the client terminal device encrypts at least the game results using the entry password so as to form a game result application password,
and the communication means performing on-line application to the server device for the game results application password formed by the client terminal device.

4. The tournament system according to claim 1, wherein, in applying for the game results, the communication means sends to the server device a client ID number, which is a characteristic identification number applied to the client terminal device being used by the player, along with the game results,
the server device has a client ID number storage means for storing the client ID number, compares the client identification number sent together with the game results from the player via the communication means and the client identification number stored in the client ID storage means and, in the case in which there is coincidence therebetween, accepts the game results applied for.

5. The tournament system according to claim 1, wherein the client terminal device and communication means are formed together as one.

6. A method for executing a tournament, comprising the steps of:
executing a predetermined game in an off-line condition, in accordance with operation of a client terminal device by a player;
on-line application for game results of a game executed on the client terminal device to a server device on a predetermined network, via a communication means; and
holding of a tournament on the server device, with support of a sponsor, in which each player competes for position, based on game results applied for on-line via the communication means.

7. The method for executing a tournament according to claim 6, further comprising the steps of:
storing advertising information of the sponsor into an advertising information database; and
the server device sending of advertising information in the advertising information database to players participating in the tournament.

8. The method for executing a tournament according to claim 6, further comprising the steps of:
issuing an entry password to each player for participating in the tournament;
forming a game results application password by encrypting at least the game results using the entry password; and
performing on-line application to the server device for the game results application password formed at the client terminal device via the communication means.

9. The method for executing a tournament according to claim 6, further comprising the steps of:
at the time of application for game results, sending a client identification number, which is a characteristic identification number given to a client terminal device used by that player, to the server device along with the game results;
the server device storing the client identification numbers and, when the game results from a player are sent together with the client identification number, comparing the client identification number sent from the player with the client identification number previously stored and, if there is coincidence therebetween, accepting the applied for game results.

10. The method for executing a tournament according to claim 6, wherein the client terminal device and communication means are formed together as one.

11. A server device comprising:
means for holding a tournament in which players compete for ranking based on results applied for on-line from the players.

12. The server device according to claim 11, further comprising:
an advertising information database into which is stored advertising information of the sponsor; and
means for sending to each player participating in the tournament advertising information stored in the advertising information database.

13. The server device according to claim 11, further comprising:
means for issuing an entry password for participating in the tournament to each player individually via a predetermined network.

14. The server device according to claim 11, further comprising:
means for storing a client identification number, which is a characteristic identification number of each player;
means for comparing a client identification number sent together with game results with a client identification number stored in the client identification number storage means; and
means for accepting an applied for game result in the case in which there is coincidence between the sent client identification number and the client identification number of a player stored in the client identification number storage means.

15. A tournament execution program to be executed on a computer, comprising:
processing for holding a tournament with support from a sponsor, in which players compete for ranking based on results applied for on-line from the players.

16. A computer-readable recording medium having recorded therein a tournament execution program to be executed on a computer, the tournament execution program comprising:
processing for holding a tournament in which players compete for ranking based on results applied for on-line from the players.

17. The computer-readable recording medium according to claim 16, wherein the tournament execution program further comprises processing for sending to each player participating in the tournament advertising information of the sponsor.

18. The computer-readable recording medium according to claim 16, wherein the tournament execution program further comprises processing for issuing an entry password for participating in the tournament to each player via a predetermined network.

19. The computer-readable recording medium according to claim 16, wherein the tournament execution program further comprises: processing for comparing a client identification number sent along with game results with a client identification number stored in the client identification number storage means; and
processing for accepting the applied for game results if there is coincidence between the client identification number sent along with game results and the client identification number stored in the client identification number storage means.
